(19) United States
(12) Patent Application Publication
(10) Pub. No.: US 2012/0295996 A1
(43) Pub. Date: Nov. 22, 2012

(54) Fire Retardant Composition

(76) Inventors: Minji Wang, Harbin (CN); Xiaoying Wang, Harbin (CN)

(21) Appl. No.: 13/441,977

(22) Filed: Apr. 9, 2012

(30) Foreign Application Priority Data
Apr. 8, 2011 (CA) 2736682

(51) Int. Cl. C09D 133/08; C08K 13/02

(52) U.S. Cl. 521/85; 524/100

(57) ABSTRACT

A fire retardant composition comprising the following amounts by weight: blowing type fire-retardant coat base ingredients in an amount of 8-15%, a fire-retardant smoke suppression agent fire retardant agent in an amount of 10-14%, the fire-retardant smoke suppression agent including Antimony (Sb), Boron (B), Zinc (Zn), Magnesium (Mg), Calcium Carbonate (CaCO₃) and Phosphorus (P), a dehydration char formation promoting agent in an amount of 8-12%, a fire-retardant smoke suppression curing agent in an amount of 6-8%, a fire-retardant heat absorb expanding agent in an amount of 3-3.5%, a fire and heat resistance base agent in an amount of 11-23.5%, dispersant in an amount of 0.2-0.6%; a defoaming agent in an amount of 0.1-0.2%, a wetting agent in an amount of 0.1-0.2%, a film-forming additive in an amount of 0.1-0.5%;, pigments in an amount of 11-15%; and water in an amount of 22-31%.

### TECHNICAL FIELD

Fire retardant paint and production method.

### BACKGROUND

Blowing or intumescent type of fire-retardant paint has been in use for years, and many previous inventions have made improvements to it. However, due to the increasing requirements on fire-retardant performance, safety issues and environmental issues, the current blowing or intumescent types of fire-retardant paint available are far behind people's demand. In addition, more and more research shows that the smoke and gases released from fire-retardant paint and other painted surfaces are the most deadly factors in a fire, not the flames and high heat. As a result, the current market urgently needs a new generation of fire-retardant paints.

Current blowing type fire-retardant paints can be generally classified as either solvent type fire-retardant paints or water-based fire-retardant paints. Solvent type fire-retardant paints can very seriously harm both the environment and people's health, and has been eliminated by the market. Many countries have laws carrying large penalties for use of solvent type fire-retardant paints.

Water-based organic fire-retardant paint is made with base ingredients such as self-cross linking acrylic binder and polystyrene and its advantages are better cold resistance and weatherability. However, its fire-retardant ability, heat resistance and permeability are not very good. Also, it binds dust easily and becomes very brittle under low temperatures.

Water-based inorganic fire-retardant paint uses silicate as its base ingredient, but it releases smoke and toxic gas when it meets flame or high heat. To solve this problem, people put their focus on different silicate types, including hydrated silicate and waterproof silicate. However, their disadvantages are obvious too. For example, as the temperature of the fire-retardant film increases hydrogen silicate carbon layers begin to melt; as a result the fire-retardant performance is almost gone at the middle to late stage of a fire. Waterproof silicate's disadvantage is that it shows strong basic properties when it meets water and speeds up the passivation of metal and damages the primer. As a result, when the fire-retardant paint film meets water, the alkali metal ions in the film, and the film itself, will dissolve into the water.

Water-based organic and inorganic compound fire-retardant paint has the advantages of both organic and inorganic fire-retardant paints. However, it requires special organic synthetic emulsion, and the cost is high. In addition, it requires other fire-retardant ingredients such as batching material to be mixed in before use; it cannot stand as an independent fire-retardant paint.

### SUMMARY

A fire retardant composition comprising blowing type fire-retardant coat base ingredients in an amount by weight of 8-15%, a fire-retardant smoke suppression agent fire retardant agent in an amount by weight of 10-14%, the fire-retardant smoke suppression agent including Antimony (Sb), Boron (B), Zinc (Zn), Magnesium (Mg), Calcium Carbonate (CaCO₃) and Phosphorus (P), a dehydration char formation promoting agent in an amount by weight of 8-12%, a fire-retardant smoke suppression curing agent in an amount by weight of 6-8%, a fire-retardant heat absorb expanding agent in an amount by weight of 3-3.5%, a fire and heat resistance base agent in an amount by weight of 11-23.5%, a Dispersant Agent by weight of 0.2-0.6%; a defoaming agent in an amount by weight of 0.1-0.2%, a wetting agent in an amount by weight of 0.1-0.2%, a film-forming additive in an amount by weight of 0.1-0.5%; pigments in an amount by weight of 11-15%; and water in an amount by weight of 22-31%. The Antimony (Sb), Boron (B), Zinc (Zn), Magnesium (Mg) and Phosphorus (P) are preferably included as elemental metals and the metals and the Calcium Carbonate (CaCO₃) are preferably included in powdered form.

These and other aspects of the composition and method are set out in the claims, which are incorporated here by reference.

### DETAILED DESCRIPTION

In the fire retardant paint composition disclosed, there are included non-toxic and harmless ingredients, while making sure the fire-retardant paint is still environmental friendly, has a low volatile organic compound component, and is non-toxic and harmless after mixing all the ingredients together. The fire retardant composition is a blowing type fire-retardant paint system that releases no smoke or smell when exposed to fire or high temperature under standard test conditions, and that has a zero flame spread ratio when applied on wood products, metal products, paper products and drywall product. This improved fire and heat retardant ability is achieved with a very thin layer of paint film. The fire-retardant paint may be used as primer paint and final coat paint with any sheen grade, such as flat, egg shell and semi-gloss, and that may be tinted in any color (for example up to 3% of tint by volume), with no affect on other performance such as fire-retardant ability, heat-retardant ability, environmental friendliness and water resistance. The fire-retardant paint helps protect surfaces against rust, damage or any corrosion and is convenient to use, with reasonable cost.

Preferred Ingredients Formula (all percentages are by volume of the total amount of the composition unless stated otherwise);

Standard blowing type fire-retardant coat base ingredients (Blowing agent, Foaming agent, carbon agent): 8-15%;

Synthetic fire-retardant smoke suppression agent (Antimony (Sb), Boron (B), Zinc (Zn), Magnesium (Mg), Calcium Carbonate (CaCO₃), Phosphorus (P)): 10-14%;

Dehydration catalyst or char formation promoting agent, such as ammonium tripolyphosphate, ammonium phophates, phosphates, sulfate, borate: 8-12%;

Fire-Retardant smoke suppression curing agent, such as starch, dextrose, sorbitol, pentaerythritol, dispentaerythritol, tripentaerythritol, urea resin, amino resin, polyurethane resin, epoxy resin: 6-8%;

Fire-retardant heat absorb expanding agent, such as melamine, urea, urea-formaldehyle resin, dicyandiamide polyamide, polyurea, oxidized paraffin: 3-3.5%;

Fire and heat resistance base agent, such as vinyl acetate-acrylate latex, polyacrylate emulsion, polyvinyl acetate emulsion, polyurethane resin, polyamide resin, chloroprene rubber emulsion, water-solubility melamine formaldehyde resin: 11-23.5%;

Dispersant Agent, for example an inorganic dispersant such as silicate type, carbonate type and alkali metals phosphate type, such as sodium hexametaphosphate, sodium tripolyphosphate, sodium pyrophate, or a polymeric dispersant, such as polycarboxylate SN-5040 dispersant, OROTAN dispersant, unsaturated polyesteramide and high molecular weight phenolic ester and other anionic compound: 0.2-0.6%;

Defoamer agent, such as mineral oil and silicon substrate mixtures, emulsification of aliphatic hydrocarbon, no-silicon organic hydrocarbon, polyether organic compounds, polyxyethylene mixture: 0.1-0.2%;

Wetting agent, such as alkyl sodium benzenesulfonate, sulfonated castor oil, Sodium dodecyl sulphate: 0.1-0.2%;

Film-forming additive, such as propanediol ethers, acetate: 0.1-0.5%;

Bactericide, such as C₈CL₄N₂, C₁₁H₁₉NOS, C₄H₅NOS: (optional): 0.2%.

Thickener, such as modified polyacrylate, carbamate ethoxylated polymer, non-ionic polyurethane polymer, acrylate cross linker copolymer, hydroxyethyl cellulose, mixture of cellulose: (optional) 0.6-1.2%;

Modifier, such as sodium methyl silicate, potassium silicate, Aqueous ammonia, potassium hydroxide: (Optional) 0.1-0.2%;

Pigments, such as titanium dioxide: 11-15%;

Water: 22-31%.

The combined defoamer agent, wetting agent, film-forming agent, dispersant agent, bactericide, thickener, modifier, if present, may together comprise 3.3-5.8% of the total composition. In each case of the agents mentioned, other than the fire retardant agent, the agent may comprise one or compounds of the mentioned compounds. The dispersant may be added as an aqueous solution, for example 10% sodium hexametaphosphate aqueous solution, in which case the water content of the dispersant is included in the overall water content of the composition and the amount of dispersant is the amount of sodium hexametaphosphate.

The base material functions to provide the paint performance in normal conditions and temperatures. To meet the goal of environmental friendliness and superior performance, we chose vinyl acetate-acrylate latex and acrylate resin enamel mixture as our base material. There are other common base materials for internal water based paint as well, such as polyacrylate emulsion, polyvinyl acetate emulsion, water-soluble melamine formaldehyde resin, polyurethane resin and polyamide resin. Combinations of two or more ingredients can be chosen as the base material.

The fire-retardant agent is added to improve strength of the foam styled carbon layer. The fire-retardant agent improves the carbon layer's resistance to flames and heated air and helps prevent the carbon layer from falling off In addition, the fire-retardant agent can absorb huge amounts of heat and release inert gas, and create a heat insulated carbon layer. In one embodiment the fire retardant agent comprises: Boron 2%, Zinc 2%, Antimony 1%, Phosphorus 1.0%, Magnesium 0.2%, Calcium Carbonate 93.8%. In some embodiments, the ranges of fire-retardant agent include Boron (1.5%-5%), Zinc (1.5-5%), Antimony (0.8-2%), Phosphorus (1.0-1.4%), Magnesium (0.2-0.4%), and Calcium Carbonate(86.2-95%) where the percentages given are of the total fire retardant agent. These ranges have all be tested and found to work, as exemplified by the examples given below. The fire retardant agent is prepared by mixing all the metals together and then grind the metals to a powdered form with particles mainly less than 50 μm or preferably less than 20 μm in their greatest dimension. When these ingredients meet fire or high heat conditions, they work with the hydration catalyst, carbonific agent, and foaming agent to produce acid sources, carbon sources and steam sources. Also, these ingredients themselves function as fire-retardants and smoke suppressors, and prevent droplet formation.

The fire-retardant ability of antimony on its own is not outstanding; however, it can react with chlorine-compounds to produce antimony trichloride at the early stage of burning. Both the melting point (73.4° C.) and boiling point (223° C.) of antimony trichloride are low, and its steam density is high. As a result, the steam can enclose the fire, isolate oxygen, and retard the fire. Furthermore, antimony reacts with hydrogen halide under high temperature conditions to produce antimony trihalide. Antimony trihalide can catch the free radical H•+, •OH, H3C which helps to inhibit fire burning.

Boron and zinc are not noxious, and have low water-solubility, high thermal stability, tiny particle size, and better dispersion ability. Under high heat conditions they form a non-flammable and viscous fused solution that can cover the flammable surface in order to isolate oxygen and reflect thermal radiation from the flammable surface.

When the temperature reaches 350° C., magnesium decomposes to magnesium oxide, and dehydrates the paint film to improve the film's heat resistance ability.

Calcium carbonate is a known major filler for fire-retardant paint compositions, and also assists the production of acid. Under high heat conditions, calcium carbonate carbonizes and this helps to improve the strength of the carbon layer and to prevent the carbon layer from being crushed by the air sources.

Phosphorus produces phosphoric acid under high heat conditions. These phosphoric acid fusions cover the flammable surface and become dehydrated and carbonized, which helps to isolate heat and oxygen from the flammable surface. In addition, the steam air from the dehydration of the phosphoric acid fusions also helps to absorb heat and cools down the flammable surface.

The ingredients and ratios in fire-retardant agent are carefully selected to work together to produce a tough and strong carbon layer and to induce the foaming effect, and will not inhibit the catalyst or foaming agent to release nitrogen gas, ammonia, and steam air.

Any acidic compounds that decompose after heating and have dehydrating abilities can be used as the dehydration catalyst in this fire-retardant paint. For example, the dehydration catalyst can be phosphates, sulfate, borate, acetic and amide compounds. Ammonium phosphates are the most popular dehydration catalyst. Under high heat conditions, phosphates will become phosphoric acid and then become polyphosphoric acid. Polyphosphoric acid and the carbonific agent will undergo a strong esterification reaction and induce distension. The main purpose of the dehydration catalyst is to promote and improve the thermal decomposition process, to induce the fire-retardant carbon structure, to reduce the amount of flammable ingredients resulting from the thermal decomposition process, and to produce inactive gas (inert gas). As dehydration catalysts, different phosphates have similar fire-retardant effect. However, ammonium phosphates and diammonium phosphate are better water-solubility compounds and will crystallize after the paint curing. Therefore, we prefer ammonium polyphosphate as the dehydration catalyst. In addition, the degree of polymerization can affect the performance of ammonium polyphosphate. When the degree of polymerization of ammonium polyphosphate is between 20 and 400, the paint easily precipitates and separates, and the water resistance of the curing application surface is weak. Maintaining the degree of polymerization of ammonium polyphosphate between 500 and 800 will fix the problem. As a result, we choose ammonium tripolyphosphate as our dehydration catalyst.

When cured paint film meets flame or high heat, the carbonific agent (carbon producing agent) will undergo a dehydration reaction and form carbon layers under the effects of the dehydration catalyst. There are three types of carbonific agent: (1) carbohydrates, for example starch and dextrose; (2) polyols, for example sorbitol, pentaerythritol, dipentaerythritol and tripentaerythritol; (3) resin, for example urea resin, amino resin, polyurethane resin and epoxy resin. Two factors determine the efficiency of the carbonific agent. The first factor is the carbon content and quantity of hydroxyl functional groups. Carbon content determines the carbonization speed. The quantity of hydroxyl functional groups determines the dehydration speed and foaming speed. High carbon content and low reaction speed is the optimal choice. The other factor is the decomposition temperature of the carbonific agent. If ammonium tripolyphosphate is used as our dehydration catalyst, high thermal stability carbonific agent should be chosen, for example pentaerythritol, dipentaerythritol, and tripentaerythritol. Starch has a similar carbon content and quantity of hydroxyl functional groups as pentaerythritol, dipentaerythritol and tripentaerythritol, however, starch provides much worse fire-retardant performance. The reason is that starch's decomposition temperature (150° C.) is way lower than ammonium tripolyphosphate's decomposition temperature (212° C.). The starch will be decomposed into large amounts of flammable tars before the dehydration catalyst (ammonium tripolyphosphate) decomposes. As a result, starch is not a favorable choice to produce carbon layers. In contrast, pentaerythritol's decomposition temperature is 280° C. Pentaerythritol can react with phosphoric acid, which decomposes from ammonium tripolyphosphate, to form carbon layers. In addition, dipentaerythritol and tripentaerythritol have better overall performance than pentaerythritol, however they are more expensive. Therefore, we prefer pentaerythritol as our carbonific agent.

Dispersant Agent is working as a dispersant and it also has the function of sorting water, slowing the corrosion of the applied surface. Especially, it sucks humidity in the air and works with the film-foaming agent to film. The dispersant agent may be one or more Inorganic Dispersant Agents and may include a Polymer Dispersant. If present, the polymer dispersant agent may be present in an amount by weight of 0.1-0.3%.

In our formula, we prefer melamine as the foaming agent. Melamine releases inert gas when it meets flame or high heat, and expands and induces the paint film to form a foam styled carbon layer. Other common foaming agents include urea, urea-formaldehyde resin, dicyandiamide, polyamide, melamine resin, polyuria and oxidized paraffin (wax). The major reason we choose melamine as our foaming agent is to optimize fire-retardant performance by having a foaming agent that releases inert gas, a dehydration catalyst that decomposes and releases acid, and a carbonific agent that dehydrates and carbonizes at similar reaction temperatures.

There are many kinds of defoamer agent that may be used, such as mineral oil and silicon substrate mixtures, emulsification of aliphatic hydrocarbon, no-silicon organic hydrocarbon, no-silicon hydrocarbon, polyether organic compounds or polyxyethylene mixture. Any one of the above or more than one defoamer agent can be added into our paint. We prefer to use mineral oil and silicon substrate mixtures.

The wetting agent may be any suitable wetting agent such as alkyl sodium benzenesulfonate, sulfonated castor oil, sodium dodecyl sulfate, oleic acid or butyl alkyl thioether. Any one of the above or more than one wetting agent can be added into our paint.

The film-forming additive is preferably a strong solvent, and there are three kinds: alcohol type, alcohol ether type, and ester type. We prefer propanediol ethers and acetate as our film-foaming additive.

The Polymer Dispersant Agent may comprise unsaturated polyesteramide, high molecular weight phenolic ester and other anionic surfactant compounds. Polymer Dispersant Agent is always available as finished synthesis product.

The bactericide may be any bactericide suitable for a paint and may comprise organic nitrogen heterocyclic compounds or isthiazolinone derivatives for example. Any one of the above or more than one bactericide can be added into our paint. We prefer 1.5% isothiazoline aqueous solution in our product.

The thickener may be for example modified polyacrylate, carbamate ethoxylated polymer, nonionic polyurethane polymer, acrylate cross linker copolymer or any of various celluloses. Any one of the above or more than one thickener can be added into our paint. We prefer hydroxyethyl cellulose (HEC) in our product.

The modifier may comprise sodium methyl silicate, potassium silicate, aqueous ammonia, potassium hydroxide. Any one of the above or more than one modifier may be added into our paint.

While compounds having specific functionality have been disclosed, it should be noted that more than one functionality may be provided by a single compound.

Manufacturing Method

The manufacturing environment temperature should be above 5° C. and below 40° C. and the manufacturing environment humidity should be less than 90%. Add dispersant such as an Inorganic Dispersant Agent into water and mix at a low mixing rate until the solution reaches stirring uniformity. Then add in the defoamer agent, wetting agent, film-forming additive and Polymer Dispersant Agent, if present, one by one and mix at a low rate until reaching uniformity. Next, add in the standard blowing type fire-retardant coat base ingredients. Increase the mixing speed up to mid speed (400-600 turns/min) and mix for 7-10 minutes. Then add in the dehydration char formation promoting agent and mix for 7-10 minutes. Then add in the fire-retardant smoke suppression curing agent and mix for 7-10 minutes. Then add in the fire-retardant heat absorb expanding agent and mix for 10-20 minutes. Then add in the synthetic fire-retardant smoke suppression agent and mix for 30 minutes. Then use a triple-toll grinder and sand mill to grind the mixture of fire retardant agent until the fineness of the mixture is less than 50 μm or better still less than 20 μm. Mix the liquid mixture again at mid speed (400-600 turns/min), then add in the fire and heat resistance base agent, bactericide, thickener and modifier (if present), and mix until the mixture viscosity reaches 85-90 ku and the PH value of the mixture reaches 6.5-7.5. Finally, filter the paint and package it.

Examples of Invention Tests

These tests tested the paint as a whole finished product; the results were achieved by the whole composition of the product. The examples show proof of the captured tasks. Example 1 shows the environmentally friendly function. Example 2 shows that the paint produces no flame and no smoke. Examples 3-8 show that the paint has a good fire-retardant performance and produces no smoke on different surfaces. Example 9 shows the shelf life. Example 10 shows that tints can be added into the paint.

The following formulations were used in the noted examples:

Formulation of Example 1

Water 200 kg, 10% Sodium Hexametaphosphate aqueous solution 25 kg, F111 Defoamer agent 2 kg, Type 1130 Wetting agent 2 kg, Texanol ester alcohol (Texanol 12) Film-forming additive 3 kg, SN-5040 Dispersant agent 3 kg, ammonium tripolyphosphate 100 kg, melamine 100 kg, pentaerythritol 70 kg, Synthetic fire-retardant smoke suppression agent 140 kg (Antimony 1.4 kg, Boron 2.8 kg, Zinc 2.8 kg, Magnesium 0.28 kg, Calcium Carbonate 131.32 kg, Phosphorus 1.4 kg), titanium dioxide 110 kg, ROVACE™ 661 Vinyl acetate-acrylate copolymerization emulsion 235 kg, LXF chlorine dioxide Bactericide 2 kg, DR-72 Thickener 6 kg, AMP-95 Modifier 2 kg.

Formulation of Example 2

Water 280 kg, 10% Sodium Hexametaphosphate aqueous solution 20 kg, NXZ Defoamer agent 1 kg, PE100 Wetting agent 1 kg, Eastman Texanol Film-forming additive 1 kg, SN-5040 Dispersant agent 1 kg, ammonium tripolyphosphate 200 kg, melamine 80 kg, pentaerythritol 80 kg, Synthetic fire-retardant smoke suppression agent 100 kg (Antimony 1 kg, Boron 2 kg, Zinc 2 kg, Magnesium 0.2 kg, Calcium Carbonate 93.8 kg, Phosphorus 1 kg), titanium dioxide 114 kg, ROVACE™ 661 Vinyl acetate-acrylate copolymerization emulsion 110 kg, LXF chlorine dioxide Bactericide 2 kg, DR-72 Thickener 9 kg, AMP-95 Modifier 1 kg.

Formulation of Example 3

Water 220 kg, 10% Sodium Hexametaphosphate aqueous solution 30 kg, Type 12593 Defoamer agent 1.5 kg, Type OP-10 Wetting agent 1 kg, Texanol ester alcohol (Texanol 12) Film-forming additive 5 kg, OROTAN Dispersant agent 2 kg, ammonium tripolyphosphate 130 kg, melamine 100 kg, pentaerythritol 85 kg, Synthetic fire-retardant smoke suppression agent 120 kg (Antimony 1.2 kg, Boron 2.4 kg, Zinc 2.4 kg, Magnesium 0.24 kg, Calcium Carbonate 112.56 kg, Phosphorus 1.2 kg), titanium dioxide 150 kg, ROVACE™ 661 Vinyl acetate-acrylate copolymerization emulsion 140 kg, Preventol D7 Bactericide 2 kg, ASE-60 Thickener 12 kg, AMP-95 Modifier 1.5 kg.

### EXAMPLE 1

The NRC (National Research Council Canada) has developed tests to evaluate the disclosed fire retardant composition. The test results show that this product is a safe and green product to use and that it meets the requirements of the National Building Code 2005. Also, this fire retardant composition is eligible to apply for a CAN/ULC certificate.

### EXAMPLE 2

The CAN/ULC-S102 Surface Burning Characteristics test has been developed by Exova in accordance with Canadian Construction Material Center and Canadian Fire Department regulations. This invention passed the tests with exceptionally outstanding marks, including a Flame Spread Value of 0, and Smoke Developed Value of 44.

### EXAMPLE 3

We applied a 0.8 mm thickness of the disclosed fire retardant composition on a 10 cm×10 cm×1.3 cm piece of standard drywall and tested it using an alcohol blast burner. Two thermal imaging video cameras recorded the temperature of the bottom side and top side of the drywall separately. After 45 minutes of burning, the thermal imaging video cameras readings were 1277° C. on the burning side (bottom side) of the drywall and <100° C. on the top side of the drywall. No smoke or smell was produced during the test and the back side of the drywall was touchable throughout the entire test. There was no crack formation or damage on both sides of the drywall after the test, and the back side of the drywall did not show any discoloration after the test.

### EXAMPLE 4

We applied a 0.8 mm thickness of the disclosed fire retardant composition onto a 10 cm×10 cm×0.95 cm piece of OSB (Oriented Strand Board) and tested it using an alcohol blast burner. Two thermal imaging video cameras were used to record the temperature of the bottom side and top side of the OSB separately. After 45 minutes of burning, the thermal imaging video cameras readings were 1150° C. on the burning side (bottom side) of the OSB and <100° C. on the top side of the OSB. No smoke or smell was produced and the back side of the OSB was touchable throughout the entire test. There was no crack formation or damage on both sides of the OSB after the test, and the back side of the OSB did not show any discoloration after the test.

### EXAMPLE 5

We applied a 0.8 mm thickness of the disclosed fire retardant composition onto a 10 cm×10 cm×0.3 cm piece of Oak Laminate and tested it using an alcohol blast burner. Two thermal imaging video cameras were used to record the temperature of the bottom side and top side of the Oak Laminate separately. After 45 minutes of burning, the thermal imaging video cameras readings were 1150° C. on the burning side (bottom side) of the Oak Laminate and <100° C. on the top side of the Oak Laminate. No smoke or smell was produced and the back side of the Oak Laminate was touchable throughout the entire test. There was no crack formation or damage on both sides of the Oak Laminate after the test, and the back side of the Oak Laminate did not show any discoloration after the test.

### EXAMPLE 6

We applied a 0.8 mm thickness of the disclosed fire retardant composition on a 10 cm×10 cm×0.05 cm piece of metal and tested it using an alcohol blast burner. Two thermal imaging video cameras were used to record the temperature of the bottom side and top side of the metal separately. After 45 minutes of burning, the thermal imaging video cameras readings are 1170° C. on the burning side (bottom side) of the metal and <216.8° C. on the top side of the metal. No smoke or smell was produced during the whole test. There was no crack formation or damage on both sides of the metal after the test.

### EXAMPLE 7

We applied a 0.8 mm thickness of the disclosed fire retardant composition on a 10 cm×10 cm×0.1 cm piece of paper cardboard and tested it using an alcohol blast burner. Two thermal imaging video cameras were used to record the temperature of the bottom side and top side of the paper cardboard separately. After 30 minutes of burning, the thermal imagine video cameras readings were 1170° C. on the burning side (bottom side) of the paper card board and <205° C. on the top side of the paper cardboard. No smoke or smell was produced during the whole test. There was no crack formation or damage on both sides of the paper cardboard after the test.

### EXAMPLE 8

We applied a 0.8 mm thickness of the disclosed fire retardant composition onto a 10 cm×10 cm×0.95 cm piece of OSB (Oriented Strand Board) and tested it using an alcohol blast burner. Two thermal imaging video cameras were used to record the temperature of the bottom side and top side of the OSB separately. After 120 minutes of burning, the OSB started to melt, but no flame was observed. The thermal imaging video cameras readings were 1200° C. on the burning side (bottom side) of the OSB and <205° C. on the top side of the OSB. No smoke or smell was produced during the whole test.

### EXAMPLE 9

We applied a 0.8 mm thickness of a 2 year old sample of our disclosed fire retardant composition (to restore the original viscosity we mixed in some water before use) We applied a 0.8 mm thickness of the invention product onto a 10 cm×10 cm×0.95 cm piece of OSB (Oriented Strand Board) and tested it using an alcohol blast burner under the same conditions as in Example 4. The test results were the same as in Example 4.

### EXAMPLE 10

We separately added 3% of red color tint, yellow color tint, and blue color tint into the disclosed fire retardant composition with different gloss finishes (flat, egg shell, semi-gloss). We then applied the tinted paint samples on three pieces of 10 cm×10 cm×0.95 cm OSB. Using the same test conditions as in Example 4, we found the same test results as shown in Example 4.

This disclosed fire retardant composition builds on the basic ideas of the traditional blowing type fire-retardant paint type and is produced and processed using carefully controlled amounts of specific ingredients in scientific and reasonable manufacturing techniques. This disclosed fire retardant composition is a fire-retardant paint that is smoke-free, toxin-free, environmentally friendly, shows supreme and stable performance with regards to both its fire-retardant and heat-retardant properties, has no need to add other fire-retardant mixtures or additives before use, can be used as both primer and final coat, shows no change in performance upon the addition of tinting, has outstanding decoration ability and durability, has a reasonable cost, and is easy to use, manufacture, ship and store.

Immaterial modifications may be made to the embodiments described here without departing from what is covered by the claims.

In the claims, the word “comprising” is used in its inclusive sense and does not exclude other elements being present. The indefinite article “a” before a claim feature does not exclude more than one of the feature being present. Each one of the individual features described here may be used in one or more embodiments and is not, by virtue only of being described here, to be construed as essential to all embodiments as defined by the claims.

1. A fire retardant composition comprising:
blowing type fire-retardant coat base ingredients in an amount by weight of 8-15%;
a fire-retardant smoke suppression agent in an amount by weight of 10-14%, the fire-retardant smoke suppression agent including Antimony (Sb), Boron (B), Zinc (Zn), Magnesium (Mg), Calcium Carbonate (CaCO₃) and Phosphorus (P);
a dehydration char formation promoting agent in an amount by weight of 8-12%;
a fire-retardant smoke suppression curing agent in an amount by weight of 6-8%;
a fire-retardant heat absorb expanding agent in an amount by weight of 3-3.5%;
a fire and heat resistance base agent in an amount by weight of 11-23.5%;
a dispersant agent in an amount by weight of 0.2-0.6%;
a &foaming agent in an amount by weight of 0.1-0.2%;
a wetting agent in an amount by weight of 0.1-0.2%;
a film-forming additive in an amount by weight of 0.1-0.5%;
pigments in an amount by weight of 11-15%; and
water in an amount by weight of 22-31%.

2. The fire retardant composition of claim 1 in which the Antimony (Sb), Boron (B), Zinc (Zn), Magnesium (Mg), and Phosphorus (P) are included a elemental metals.

3. The fire retardant composition of claim 1 which the Antimony (Sb), Boron (B), Zinc (Zn), Magnesium (Mg), Phosphorus (P) and Calcium Carbonate are included in powdered form.

4. The fire retardant composition of claim 1 in which the blowing type fire-retardant coat base ingredients comprises a blowing agent, a foaming agent and a carbon agent.

5. The fire retardant composition of claim 1 in which the dehydration char formation promoting agent comprises at least one of ammonium tripolyphosphate, ammonium phosphates, phosphates, sulfate and borate.

6. The fire retardant composition of claim 1 in which the fire-retardant smoke suppression curing agent comprises at least one of starch, dextrose, sorbitol, pentaerythritol, dispentaerythritol, tripentaerythritol, urea resin, amino resin, polyurethane resin and epoxy resin.

7. The fire retardant composition of claim 1 in which the fire-retardant heat absorb expanding agent comprises at least one of melamine, urea, urea-formaldehyle resin, dicyandiamide polyamide, polyuria and oxidized paraffin.

8. The fire retardant composition of claim 1 in which the fire and heat resistance base agent comprises at least one of vinyl acetate-acrylate latex, polyacrylate emulsion, polyvinyl acetate emulsion, polyurethane resin, polyamide resin. chloroprene rubber emulsion and water-soluble melamine formaldehyde resin.

9. The fire retardant composition of claim 1 in which the defoamer agent comprises at least one of mineral oil and silicon substrate mixtures, emulsification of aliphatic hydrocarbon, no-silicon organic hydrocarbon, polyether organic compounds and polyxyethylene mixture.

10. The fire retardant composition of claim 1 in which the wetting agent comprises at least one of alkyl sodium benzenesulfonate, sulfonated castor oil and sodium dodecyl sulphate.

11. The fire retardant composition of claim 1 in which the film-forming additive comprises at least one of propanediol ethers and acetate.

12. The fire retardant composition of claim 1 in which the dispersant agent comprises sodium hexametaphosphate, and one or more of unsaturated polyesteramide and high molecular weight phenolic ester compound.

13. The fire retardant composition of claim 1 in which the fire-retardant smoke suppression agent comprises by weight: Boron (1.5%-5%), Zinc (1.5-5%), Antimony (0.8-2%), Phosphorus (1.0-1.4%), Magnesium (0.2-0.4%), and Calcium Carbonate (86.2-95%).
